(19) United States
(12) Patent Application Publication
(10) Pub. No.: US 2010/0067113 A1
(43) Pub. Date: Mar. 18, 2010

(54) Apparatus and Method for Displaying Hierarchical Data

(76) Inventor: Matthew John Harrison, Macclesfield (GB)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/233,506

(22) Filed: Sep. 18, 2008

(51) Int. Cl. G02B 27/64; G06F 17/30

(52) U.S. Cl. 359/555; 707/E17.122; 359/554

(57) ABSTRACT

A computer readable storage medium includes executable instructions to receive a request for tree node information and apply one or more tree node parameter limits to the request. The tree node parameter limits include a tree node level limit and a sibling node count limit. The computer readable storage medium further includes executable instructions to receive tree node objects corresponding to the tree node parameter limits, add the tree node objects to a dynamically extended tree node data structure and display a first portion of the tree node objects.

### FIELD OF THE INVENTION

The invention relates generally to passing data in a networked environment. More particularly, the invention relates to a control technique for exchanging and displaying hierarchical data.

### BACKGROUND OF THE INVENTION

Computer applications commonly use controls to display data of a hierarchical nature. Prior art approaches for implementing such controls generally involve the use of Document Object Model (DOM) trees and Paging trees. DOM based tree implementations typically perform tree control by fetching elements from a server and adding the data elements to a DOM tree structure, either statically or dynamically. However, the performance of DOM trees is impacted when a large number of elements have to be retrieved from the server, for example, in order to process a request to view the entire contents of a tree. Even if these elements can be added to the DOM tree dynamically, all these elements have to be present in the DOM tree before they can be displayed to an end user.

Page based tree implementations typically use paging models that organize the nodes of a tree as rows of stored records. However, as the nodes of the tree are either expanded or contracted, the number of visible nodes in the tree increases or decreases, resulting in the creation of a tree view that exceeds the number of rows of stored data in the paging model. These expansion and contraction states for the tree nodes have to be maintained in the server to facilitate the retrieval of stored data. In other words, in order to generate an efficient paging model to represent a tree, the entire tree must be generated at the server and arranged in the paging model so that pages of the tree can include the “virtual” elements that do not appear in the stored record dataset.

It would be desirable to develop an efficient tree control technique for the display of hierarchical tree node data. It would also be desirable to develop a tree based control system that performs efficiently with large volumes of tree node data.

### SUMMARY OF THE INVENTION

The invention includes a computer readable storage medium with executable instructions to receive a request for tree node information and apply one or more tree node parameter limits to the request. The tree node parameter limits include a tree node level limit and a sibling node count limit. The computer readable storage medium further includes executable instructions to receive tree node objects corresponding to the tree node parameter limits. Tree node objects are added to a dynamically extended tree node data structure. A first portion of the tree node objects is displayed.

### BRIEF DESCRIPTION OF THE FIGURES

The invention is more fully appreciated in connection with the following detailed description taken in conjunction with the accompanying drawings, in which:

FIG. 1 is an illustration of a network configured to display a hierarchical tree in accordance with one embodiment of the invention.

FIG. 2 is a flowchart illustrating exemplary operations performed to dynamically display hierarchical tree node data in accordance with one embodiment of the invention.

FIG. 3 is an exemplary hierarchical tree processed in accordance with one embodiment of the invention.

FIGS. 4-7 are exemplary screen shots illustrating the dynamic display of tree node data objects in a hierarchical tree in accordance with a user's request to expand or contract one or more tree node objects in the hierarchical tree.

Like reference numerals refer to corresponding parts throughout the several views of the drawings.

### DETAILED DESCRIPTION OF THE INVENTION

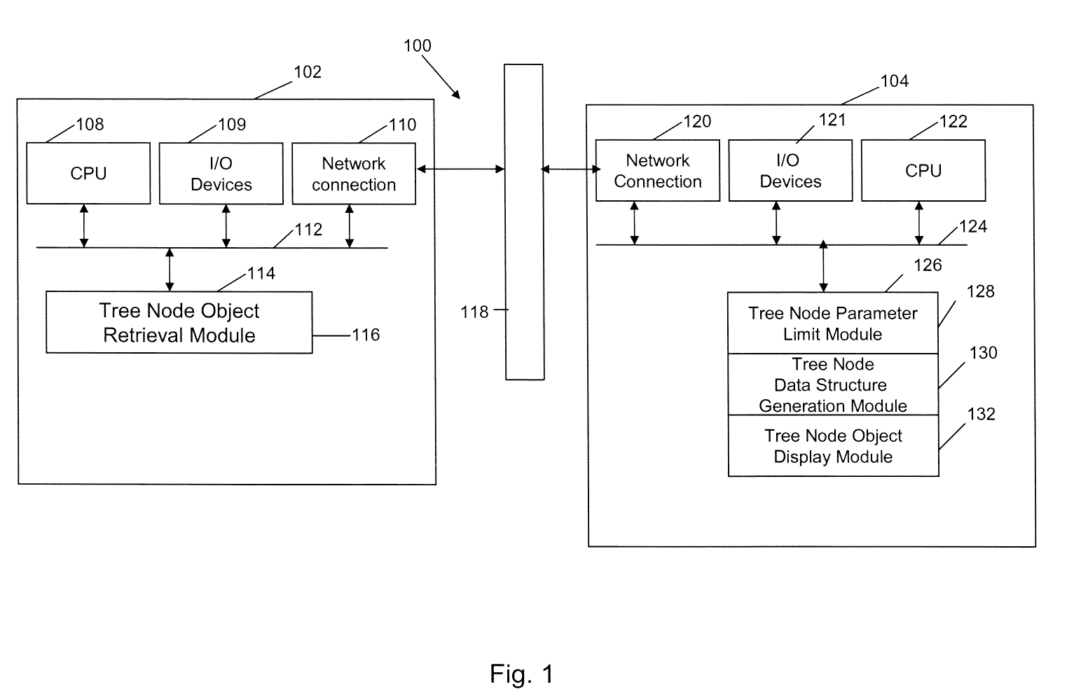

FIG. 1 is an illustration of a network 100 configured to display a hierarchical tree in accordance with one embodiment of the invention. The network 100 includes a server computer 102 connected to a client computer 104 via a communication channel 118, which may be any wired or wireless communication channel. The server computer 102 includes standard components, such as a central processing unit 108, input/output devices 109 and a network connection circuit 110, which are linked by a bus 112. The network connection circuit 110 provides connectivity to the communication channel 118, thereby allowing the server computer 102 to operate in a networked environment. A tree node object retrieval module 116 is stored in a memory 114, which is connected to the bus 112. The tree node object retrieval module 116 includes executable instructions to receive tree node parameters including a tree node level limit and a sibling node count limit from the client computer 104. The tree node object retrieval module 116 is further configured to retrieve one or more tree node objects corresponding to the tree node parameter limits and deliver the tree node objects to the client computer 104. Node parameter limits include a tree node level limit and the sibling node count limit.

The client computer 104 includes standard components, such as a network connection circuit 120, input/output devices 121 and a central processing unit 122, which are linked by a bus 124. The client computer 104 includes a tree node parameter limit module 128, a tree node data structure generation module 130 and a tree node object display module 132 stored in a memory 126, which is connected to the bus 124. The tree node parameter limit module 128 includes executable instructions to specify tree node parameter limits including a tree node level limit that specifies a limit on the number of levels in the hierarchical tree and the sibling node count limit that specifies a limit on the number of siblings at a particular level to be retrieved. The parameters may be generated automatically or they may be specified by a user in response to appropriate prompts.

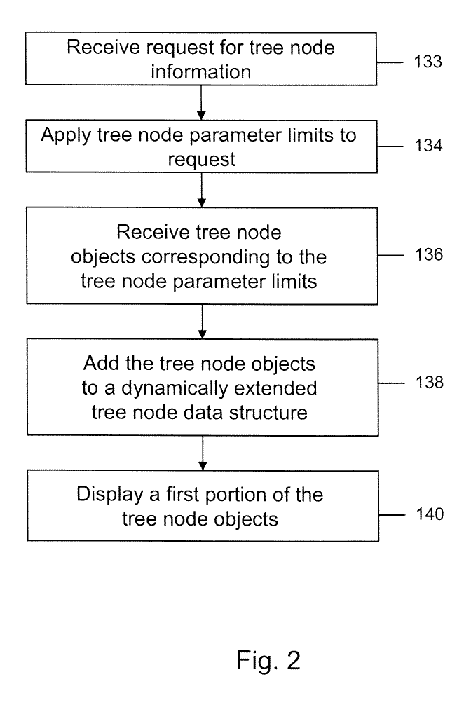

The tree node data structure generation module 130 includes executable instructions to receive tree node objects corresponding to the tree node parameter limits and add the tree node objects. The tree node objects are added to a dynamically extended tree node data structure. The tree node object display module 132 includes executable instructions to display the tree node objects. The operations performed by the executable modules are discussed in greater detail with respect to FIGS. 2-7.

It should be noted that the executable modules stored in memory units 114 and 126 are exemplary. Additional modules, such as an operating system module or graphical user interface module may also be included. It should be appreciated that the functions of the modules may be combined. In addition, the functions of the modules may be distributed across the system 100 in any number of ways. It is the functions of the invention that are significant, not where they are performed or the specific manner in which they are performed.

FIG. 2 is a flowchart illustrating exemplary operations performed to dynamically display hierarchical tree node data in accordance with one embodiment of the invention. A request for tree node information is received 133. The request may include a user's request to either expand or contract one or more tree node objects in a hierarchical tree displayed on the client computer 104. One or more tree node parameter limits are applied to the request 134. In one embodiment, the tree node parameter limit module 128 includes executable instructions to specify the tree node parameter limits. In a particular embodiment, the tree node parameter limits include a tree node level limit and a sibling node count limit. In accordance with one embodiment of the present invention, a user's request to expand a tree node object in the hierarchical tree is conditioned by a tree node level limit that specifies a limit on the number of levels in the hierarchical tree and a sibling node count limit that specifies a limit on the number of siblings at a particular level to be retrieved.

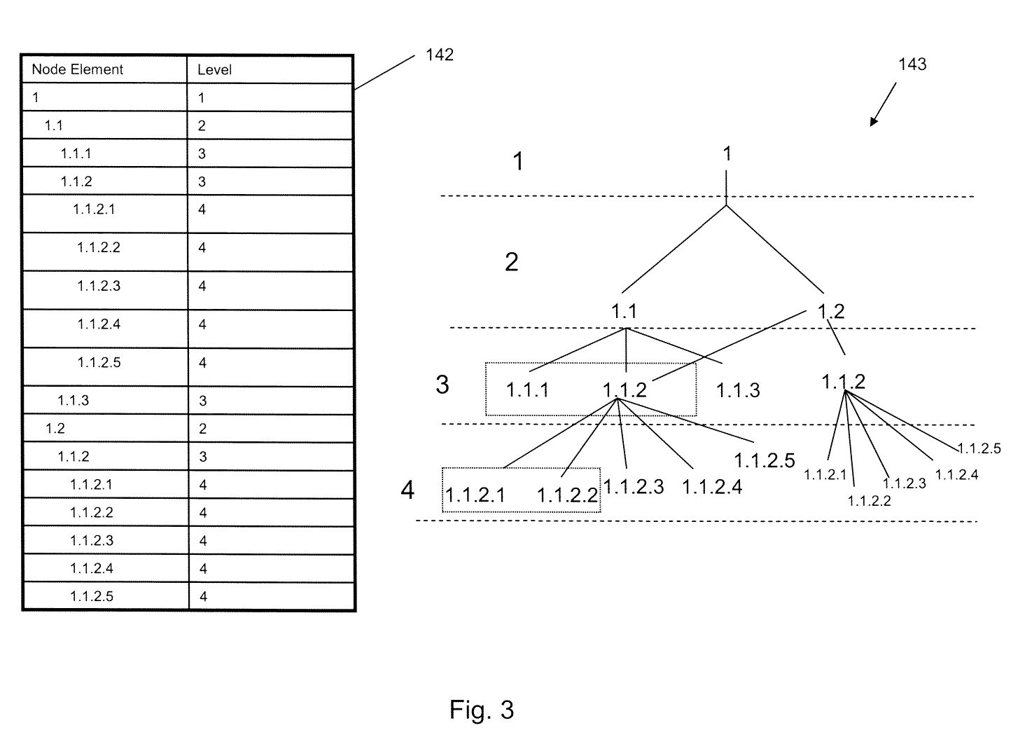

FIG. 3 illustrates an exemplary hierarchical tree processed in accordance with one embodiment of the invention. An exemplary hierarchical tree 142 is illustrated as a graph 143 of tree node objects. In an exemplary operation, a user requests to expand or contract one or more tree node objects in the hierarchical tree 142. The user's request is then translated into one or more tree node parameter limits corresponding to the request. In the illustrated example, a user's request to expand the tree node objects associated with a tree node object 1.1 present at level 2 in the hierarchical tree 142 is translated into a two level limit and a two sibling count limit. Typically, the user does not know the structure of the tree and simply requests information, with the system applying parameter limits. In this example, the values 1.1.1 and 1.1.2 present in a level immediately below the selected tree node object 1.1 and the siblings, 1.1.2.1 and 1.1.2.2 associated with the tree node object 1.1.2 are gathered. Observe that for the particular illustrated example, the tree node objects 1.1.3 in level 2 and the siblings 1.1.2.3, 1.1.2.4 and 1.1.2.5 in level 3 are not retrieved. Also note that if a user requests to expand all the tree node objects in the hierarchical tree 142, in another embodiment, the user still only receives a portion of the tree as specified by the tree node parameter limits, thereby enabling the effective tuning of the performance of the display of hierarchical tree node data for each dimension based on the user's request. In one implementation, default retrieval values for the tree node parameter limits may be established for a given hierarchical tree. For example, a flat hierarchy may be specified by a tree node level limit of 1 and a sibling node count limit of 1000. On the other hand, a deep hierarchy may be specified by a tree node level limit of 100 and a sibling node count limit of 10. Alternately, the system can use sliding level limit and sibling count values to return the maximum amount of information.

Returning again to FIG. 2, tree node objects corresponding to the tree node parameter limits are then received 136. In one embodiment, the tree node object retrieval module 116 in the server computer 102 is configured to receive the tree node parameter limits and retrieve the tree node objects corresponding to the tree node parameter limits. The tree node objects are then delivered to the client computer 104. In one embodiment, Extensible Markup Language (XML) Hyper Text Transfer Protocol (HTTP) requests are used to fetch the tree node objects, the tree node objects are retrieved in JavaScript Object Notation (JSON) format and are displayed as JavaScript objects.

The tree node objects are then added to a dynamically extended tree node data structure 138. In one embodiment, the tree node data structure is stored in the tree node data structure generation module 130 in the client computer 104. In a particular embodiment, an object definition corresponding to the retrieved tree node objects is dynamically extended as the tree node objects are directly added to a relevant point in the tree node data structure based on identifying one or more of the hierarchical relationships between the tree node objects and visible node count. The visible node count—the number of nodes not hidden by contraction—is useful for rendering the tree. The hierarchical relationships between the tree node objects, such as, for example, previous/next sibling references, and parent references. Additional tree node objects corresponding to additional tree node parameter limits may further be received and added to the dynamically extended tree node structure based on identifying one or more hierarchical relationships between the tree node objects and the additional tree node objects.

A first portion of the tree node objects is then rendered in a Document Object Model (DOM) structure corresponding to the tree node data structure and the first portion of the tree node objects is displayed 140. In another embodiment, a second portion of the tree node objects may be subsequently rendered in the Document Object Model (DOM) structure and the second portion of the tree node objects may then be displayed. Note that since the tree node data structure stores the tree node objects, the whole tree never needs to be rendered to the DOM and only a sliding viewport of the data is rendered to the DOM. The object definition corresponding to the retrieved tree node objects is dynamically extended as the tree node objects are directly added to the relevant point in the existing data tree node data structure. Tree node objects are processed after retrieval to add the previous/next sibling references, parent references and visible node count directly to the tree node data structure. Accordingly, the tree node objects stored in the tree node data structure can be utilized directly with very little processing. This stands in contrast with prior art approaches in which a DOM tree is typically created to represent an initial state of information corresponding to retrieved tree node objects, the tree node objects are processed to render the DOM elements for the tree and then the tree node objects are discarded. When new content is required, new nodes are added to the DOM tree to reflect the changed state of content and corresponding nodes have to be removed from the DOM tree if the content is to be deleted. In other words, the nodes of the DOM tree have to be altered each time to reflect the dynamic changes made to the content of the nodes in the DOM tree.

If there are more nodes available in the form of siblings or children, then this information may be included in a JSON data packet. For example, when a request for children is received, selected children may be annotated with a “hasChildren” identifier, which allows children to be retrieved at a later point in time. By not having a “hasChildren” annotation, the code assumes that the item has no children and cannot be expanded. In addition, the last child item at a level maybe annotated as “moreSiblings” if the server determines that more siblings exist than have been sent back to the client. Having a “moreSiblings” annotation allows the client code to determine if all the children in a specific level have been retrieved. Either by automation or by user interaction, the “moreSiblings” node can then be processed at a later time to retrieve the next “page” of siblings.

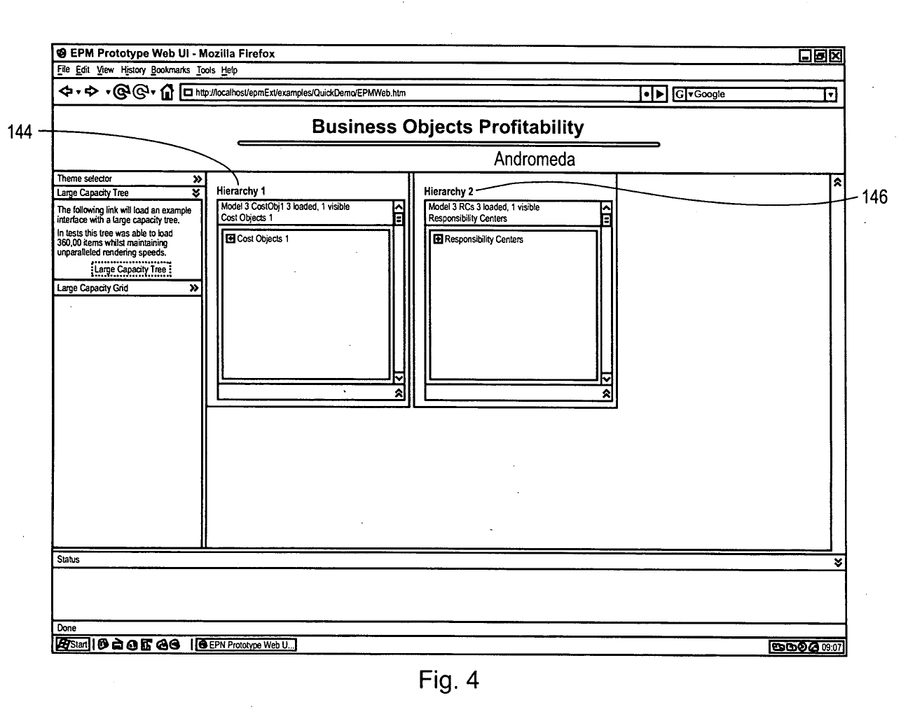

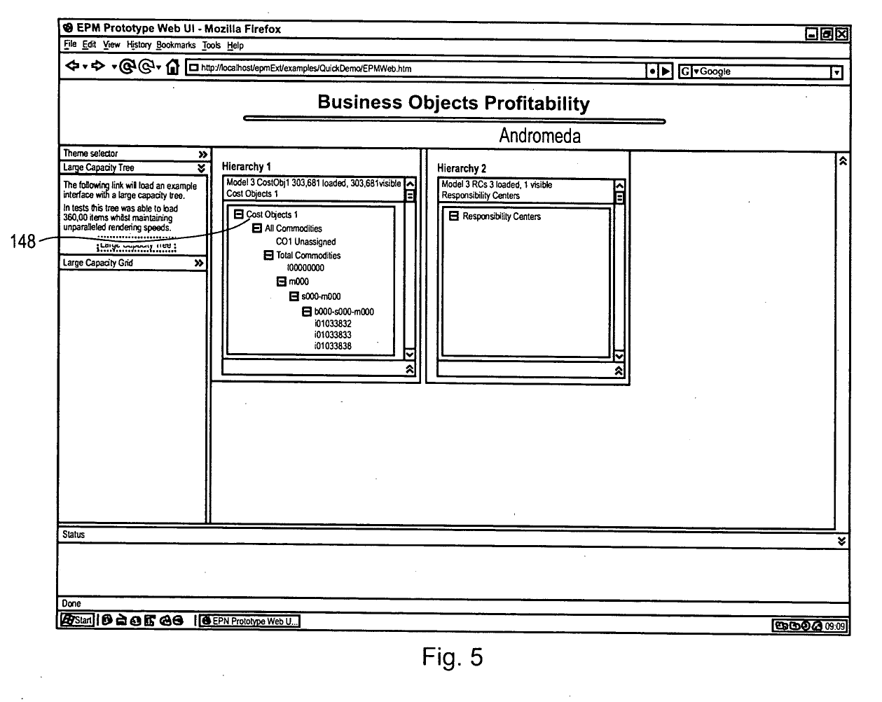

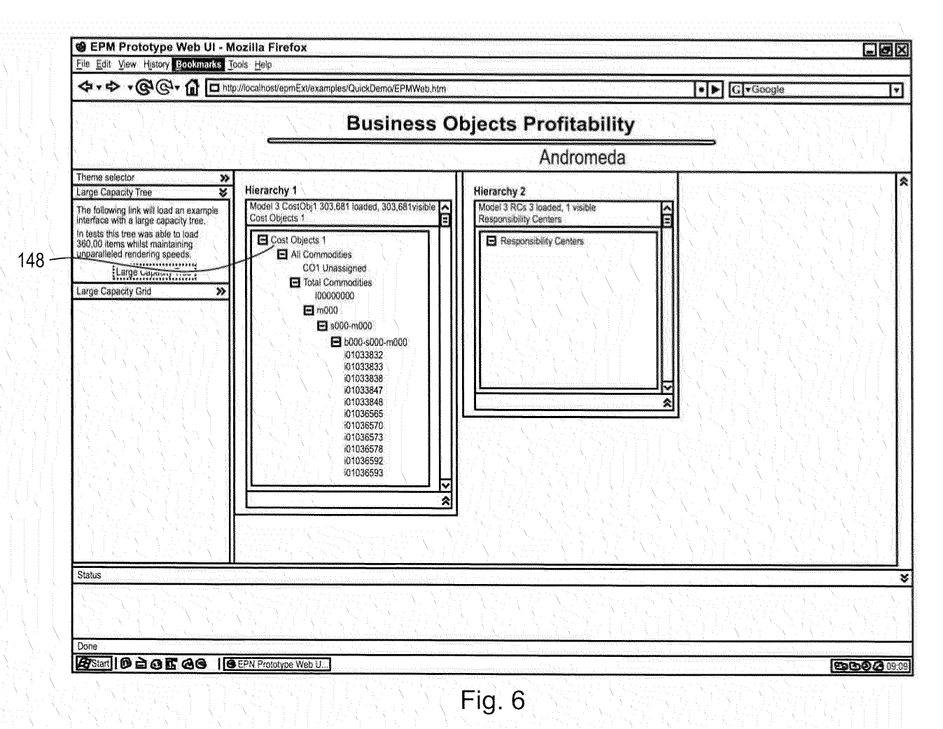

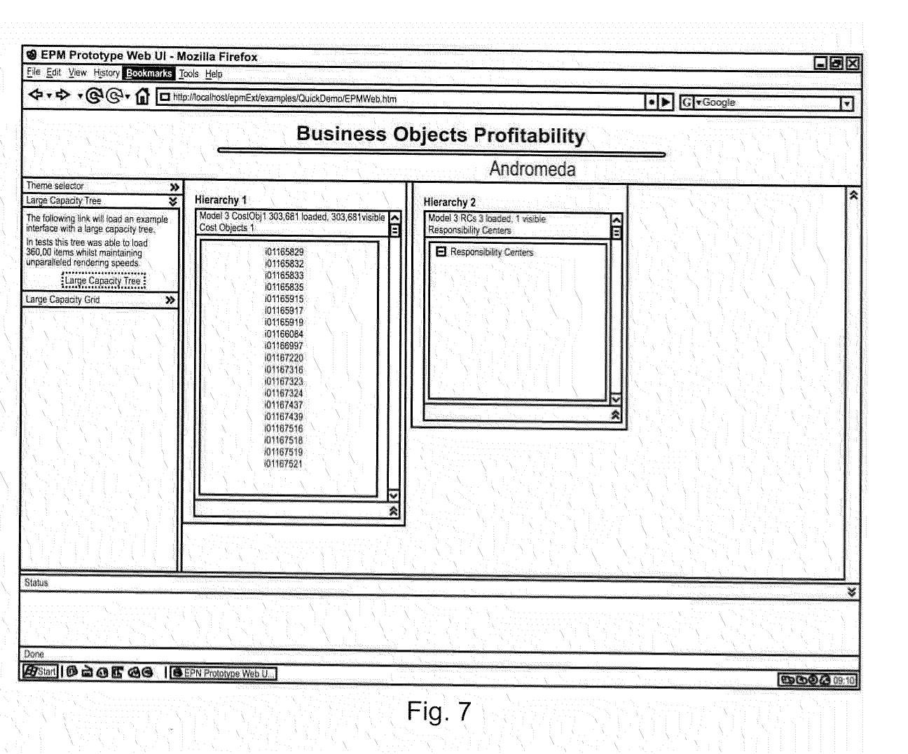

FIGS. 4-7 are exemplary screen shots illustrating the dynamic display of tree node data objects in a hierarchical tree in accordance with a user's request to expand or contract one or more tree node objects in the hierarchical tree. The nodes of the hierarchical tree are represented by a set of user interface controls that expose the branches of the tree in hierarchical levels, as the user navigates the tree. The tree structure is altered when the user expands or collapses a node in the tree. As illustrated in the screen shot shown in FIG. 4, two hierarchical trees, 144 and 146 are displayed to a user. In the exemplary screen shot shown in FIG. 5, a user requests an expansion of all the nodes in the hierarchical tree 144. In a particular example, the user performs this operation by expanding the tree node object, “Cost Objects 1” 148, as illustrated in FIG. 5. A first portion of the tree node objects is displayed as illustrated in the screen shot shown in FIG. 6. A first portion of the tree node objects associated with selected tree node object “Cost Objects 1” 148 is displayed in FIG. 6. A second portion of the tree node objects is then displayed as illustrated in the screen shot shown in FIG. 7. A second portion of the tree node objects associated with selected tree node object “Cost Objects 1” 148 is displayed in FIG. 7. Observe that the user's request to expand the tree node object “Cost Objects 1” 148 is translated into tree node parameter limits to display a first portion of tree node objects and a second portion of tree node objects as illustrated in FIGS. 6 and 7, respectively.

The principles of the invention are applicable to any hierarchical structure. References herein to trees typically conform to the use of that term in computer science, but may also be viewed in a more generalized manner as referencing a hierarchical structure. Thus, a tree may reference a directed acyclic graph, directed graph, array, table, etc.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium comprising executable instructions to:
receive a request for tree node information;
apply one or more tree node parameter limits to the request, wherein the tree node parameter limits comprise at least one of a tree node level limit and a sibling node count limit;
receive tree node objects corresponding to the tree node parameter limits;
add the tree node objects to a dynamically extended tree node data structure; and
display a first portion of the tree node objects.

2. The computer readable medium of claim 1, wherein the executable instructions to display the first portion of the tree node objects further comprises executable instructions to render the first portion of the tree node objects in a Document Object Model (DOM) structure corresponding to the tree node data structure.

3. The computer readable medium of claim 1, further comprising executable instructions to display a second portion of the tree node objects.

4. The computer readable medium of claim 3, wherein the executable instructions to display the second portion of the tree node objects further comprises executable instructions to render the second portion of the tree node objects in a Document Object Model (DOM) structure corresponding to the tree node data structure.

5. The computer readable medium of claim 1, further comprising executable instructions to receive additional tree node objects corresponding to one or more additional tree node parameter limits.

6. The computer readable medium of claim 5, further comprising executable instructions to add the additional tree node objects to the dynamically extended tree node structure based on identifying one or more hierarchical relationships between the tree node objects and the additional tree node objects.

7. The computer readable medium of 1, wherein the executable instructions to add the tree node objects comprise executable instructions to dynamically extend an object definition corresponding to the tree node objects.

8. The computer readable medium of 1, wherein the tree node parameter limits are specified using a plurality of Extensible Markup Language (XML) Hyper Text Transfer Protocol (HTTP) requests.

9. The computer readable medium of 1, further comprising executable instructions to receive the tree node objects in a Java Script Object Notation (JSON) format.

10. A computer readable storage medium comprising executable instructions to:
receive one or more tree node parameter limits, wherein the tree node parameter limits comprise at least one of a tree node level limit and a sibling node count limit;
retrieve tree node objects corresponding to the tree node parameter limits; and
deliver the tree node objects.

11. A computer readable storage medium, comprising executable instructions to:
request a set of node objects in a hierarchical data structure, wherein each node object in the set includes a definition;
receive the set of node objects, wherein each node object represents a connected part of the hierarchical data structure; and
extend the definition of each node object in the set.

12. The computer readable storage medium of claim 11, wherein the executable instructions to extend the definition of each node object include executable instructions to update a node object within an annotation comprising at least one of a child annotation and a sibling annotation.

13. The computer readable storage medium of claim 12 wherein the sibling annotation is selected from a first annotation corresponding to a representative object having more siblings than received, and a second annotation corresponding to a representative object having children.

14. The computer readable storage medium of claim 11, further comprising executable instructions to render the set of node objects forming the connected part of the hierarchical data structure.

15. The computer readable storage medium of claim 14, wherein the executable instructions to render include executable instructions to render at least one of a tree, a directed graph, an array and a table.

16. The computer readable storage medium of claim 11, further comprising executable instructions to add to a specified point in the hierarchical data structure a second set of node objects, wherein the specified point is based on at least one of a hierarchical relationship between node objects, a previous sibling reference, a next sibling reference, a parent reference and a visible node count.
